(19) United States
(12) Patent Application Publication
(10) Pub. No.: US 2003/0083220 A1
(43) Pub. Date: May 1, 2003

(54) Low ozone depleting brominated compound mixtures for use in solvent and cleaning applications

(75) Inventors: Kyle Doyel, Franklin, TN (US); Michael Bixenman, Old Hickory, TN (US); Scotty Sengsavang, Murfreesboro, TN (US); Arthur Thompson, Madison, TN (US); Valerie Porter, Antioch, TN (US); Patricia Overstreet, Murfreesboro, TN (US); Kristie Gholson, Murfreesboro, TN (US)

Correspondence Address: CROWELL & MORING LLP, INTELLECTUAL PROPERTY GROUP, P.O. BOX 14300, WASHINGTON, DC, 20044-4300, US

(73) Assignee: Kyzen Corporation, Nashville, TN

(21) Appl. No.: 10/191,280

(22) Filed: Jul. 10, 2002

Related U.S. Application Data
(62) Division of application No. 08/903,002, filed on Jul. 30, 1997, now abandoned.

(51) Int. Cl. C11D 17/00

(52) U.S. Cl. 510/412; 252/67; 510/413; 510/175; 510/177

(57) ABSTRACT

Chemical solvating, degreasing, stripping and cleaning agents. The agents are cleaning and solvating mixtures of mono brominated compounds with highly fluorinated compounds and/or other agents that improve and enhance the properties of the original mixture. The addition of these agents to the composition will modify the physical and/or cleaning characteristics of the monobrominated compound and/or monobrominated compound-fluorinated compound mixture to accomplish is desired cleaning or solvating task. These other agents are one or more of the following materials: alcohols, esters, ethers, cyclic ethers, ketones, alkanes, terpenes, dibasic esters, glycol ethers, pyrollidones, or low or non ozone depleting chlorinated and chlorinated/fluorinated hydrocarbons. These mixtures are useful in a variety of solvating, vapor degreasing, photoresist stripping, adhesive removal, aerosol, cold cleaning, and solvent cleaning applications including defluxing, drycleaning, degreasing, particle removal, metal and textile cleaning.

### BACKGROUND OF THE INVENTION

The present invention concerns chemical solvating, degreasing, stripping and cleaning agents. More particularly, this invention relates to cleaning and solvating mixtures of mono brominated compounds with highly fluorinated compounds and/or other agents that improve and enhance the properties of the original mixture.

The present invention was made in response to concerns with ozone depleting materials, and toxicity concerns with non ozone depleting chlorinated materials. In September 1987, the United States and 22 other countries signed the Montreal Protocol on Substances that Deplete the Ozone Layer (the “Protocol”). The Protocol called for a freeze in the production and consumption of ozone depleting chemicals (“ODP's” or “ODC's”) by the year 2000 for developed countries and 2010 for developing countries. In 1990 the United States enacted the Clean Air act mandating that the use of ozone depleting chemicals be phased out by the year 2000. In September 1991, the U.S. Environmental Protection Agency announced that ozone layer depletion over North America was greater than expected. In response to this announcement, President George Bush issued an executive order accelerating the phase-out of the production of ozone depleting materials to Dec. 31, 1995. More than 90 nations, representing well over 90% of the world's consumption of ODP's, have now agreed to accelerate the phase-out of production of high ozone depleting materials to Dec. 31, 1995 for developed countries and Dec. 31, 2005 for developing countries pursuant to the protocol.

Historically fluorine and chlorine based solvents were widely used for degreasing, solvating, solvent cleaning, aerosol cleaning, stripping, drying, cold cleaning, and vapor degreasing applications. In the most basic form the cleaning process required contacting a workpiece with the solvent to remove an undesired material, soil or contaminant. In solvating applications these materials were added to dissolve materials in such applications as adhesive or paint formulations.

Cold cleaning, aerosol cleaning, stripping and basic degreasing were simple applications where a number of solvents were used. In most of these processes the soiled item was immersed in the fluid, sprayed with the fluid, or wiped with cloths or similar objects that had been soaked with the fluid. The soil was removed and the item was allowed to air dry.

Drying, vapor degreasing and/or solvent cleaning consisted of exposing a room temperature workpiece to the vapors of a boiling fluid. Vapors condensing on the workpiece provided a clean distilled fluid to wash away soils and contaminants. Evaporation of the fluid from the workpiece provided a clean item similar to cleaning the same in uncontaminated fluid.

More difficult cleaning of difficult soils or stripping of siccative coatings such as photomasks and coatings required enhancing the cleaning process through the use of elevated fluid temperatures along with mechanical energy provided by pressure sprays, ultrasonic energy and or mechanical agitation of the fluid. In addition these process enhancements were also used to accelerate the cleaning process for less difficult soils, but were required for rapid cleaning of large volumes of workpieces. In these applications the use of immersion into one or more boiling sumps, combined with the use of the above mentioned process enhancements was used to remove the bulk of the contaminant. This was followed by immersion of the workpiece into a sump that contained freshly distilled fluid, then followed by exposing the workpiece to fluid vapors which condensed on the workpiece providing a final cleaning and rinsing. The workpiece was removed and the fluid evaporated. Vapor degreasers suitable in the above-described process are well known in art.

In recent years the art was continually seeking new fluorocarbon based mixtures which offered similar cleaning characteristics to the chlorinated and CFC based mixtures and azeotropes. In the early 1990's materials based on the compounds of HCFC began to appear. Three molecules in particular 1,1-dichloro-1-fluoro ethane (HCFC-141b), dichloro trifluoro ethane (HCFC-123), and dichloro pentafluoro propane (HCFC-225) were proposed as replacements for methyl chloroform and CFC blends. As more highly fluorinated materials these materials were less ozone depleting than current ODP's however these materials were weaker solvents and in order to properly clean required the use of co-solvents through the use of blends and azeotropes. Later toxicity studies performed on these materials, however, showed them to have unacceptable character for broad commercial use in cleaning applications. Consequently HCFC-123 was immediately limited in cleaning use, however new toxicity data may allow use in cleaning uses, and HCFC-141b was scheduled for phase out in the U.S. by Apr. 1, 1997. HCFC-225 is still used, however the material is scheduled for phase out by the Clean Air Act after the year 2000. Toxicity concerns with HCFC-225 are a concern to many users and the recommended commercial exposure level of blends of the various isomers of the material is 50 ppm.

The art in the mid 1990's changed as aqueous and semi-aqueous materials became the major choice of replacement for ODP's. The shift to these materials however had two drawbacks for some users. First was the requirement for new cleaning apparatus and machinery capable of handling and drying water. The second was the fact that certain niche applications in the marketplace could not tolerate the use of water in the cleaning process due to damage to the workpiece. This damage was caused by either incompatibility of water with the workpiece, or residual water remaining on the workpiece due to the geometry of the workpiece. This second factor resulted in the art shifting to processes cleaning with solvents and either rinsing with volatile flammable solvents such as acetone and isopropanol, or rinsing with highly fluorinated materials called perfluorocarbons (PFC's).

These PFC rinsing agents were investigated by some users. Other solvents such as low molecular weight alcohols, ketones and alkanes, were also evaluated since they provided users with acceptable rinsing and cleaning, however they were flammable and concerns were raised about their use in production applications. Systems that operated with these inexpensive solvents were very expensive and required explosion-proof machinery and buildings. Perfluorocarbons were deemed to be viable replacements in that they could potentially be operated in inexpensive vapor degreasing equipment such as was used for CFC's. Additionally these materials were inert, inflammable, and had very low toxicity. However, being inert these materials had no solvency, i.e., they did not dissolve the soils they were meant to remove from the workpieces, and were found to be poor cleaning materials. Other perceived drawbacks with these rinsing agents were that they were extremely expensive and required the use of modified vapor degreasers. Later work conducted by the U.S. EPA deemed PFC's to be unacceptable materials due to the fact that they had huge global warming potentials and would remain in the environment for thousands of years.

The art then evolved today to seeking materials for these specialty applications that required PFC like materials that had lower global warming potentials. Highly fluorinated materials such as hydrofluorocarbons (HFC's) and hydrofluoroethers (HFE's) and other highly fluorinated compounds are the result of the most recent disclosures. Like PFC, HFC's and HFE's exhibit the same characteristics, with the exception they are slightly less expensive than PFC's but are still orders of magnitude more expensive than CFC's and chlorinated solvents. Primarily used as rinsing, drying and inerting agents these materials exhibit poor solvency for the soils commonly encountered in most cleaning applications, and will require the use of solvent blends, co-solvent systems, and azeotrope like blends in order to effectively clean.

As a replacement for CFC compounds and mixtures in cleaning applications, the use of brominated materials has been suggested. Brominated compounds have many uses, one of which is as a flame retardant. Brominated compounds for many years have been used in the matrix of polymers where they retard the flammability of polymers and plastics. Brominated and fluorinated hydrocarbon compounds (bromo-fluorocarbons) form a class of compounds known as Halons, which were also used by themselves as fire fighting agents. These materials were extremely effective in extinguishing fires in areas which had expensive equipment and/or contained materials that were damaged by the use of water or other extinguishing agents. The halon materials were widely used on board ships and in computer rooms. Unfortunately, the combination of bromine and fluorine on a molecule was found to have a much greater impact on depleting ozone in the upper atmosphere than chlorine and fluorine. As a result these materials are scheduled for phaseout like the CFC's.

Monobrominated compounds however, are a class of chemicals that have not been as widely used as monochlorinated or multibrominated materials. Monobrominated hydrocarbons are not used as flame retardants since all of them are known to exhibit flash points, and therefore can burn given the right conditions. Monobrominated methane is probably the most abundant of the monobrominated compounds and is used widely as a fumigant in agriculture. C₂ to C₁₀ monobrominated materials for the most part have been used as chemical intermediates, and solvents in chemical processes. These materials have generally not been used in cleaning or degreasing applications due to flammability and stability concerns. Monobrominated compounds do exhibit some ozone depletion potential, although that ODP decreases with increasing carbon chain length. The only monobrominated compound that is currently under scrutiny for ozone depletion is methyl bromide, which is scheduled for phase out. Monobrominated compounds C₂ and greater all exhibit a negligible ozone depletion potential.

Recently a few cleaning and solvent applications using monobrominated hydrocarbons have been disclosed, mainly in Japan. A deterging solvent consisting of monobrominated propane with ethylene based glycol ethers and nitroalkanes as stabilizers is known. In addition the mixture can also have an assistant stabilizer consisting of chlorinated hydrocarbons, epoxides, amino alcohols, acetylene alcohols and triazoles. A deterging composition of monobrominated propane with alkyl ethylene based glycol ethers, nitroalkanes and 1,4 dioxane or trioxane is also known. Mixtures of petroleum based solvent and brominated compounds (isobromopropane) in certain ratios as cleaning agents for drycleaning are known as are halogenated solvents C₁ to C₄ that have a boiling point <100° C. and a flash point >11° C. plus a rust inhibitor for cleaning fluxes. Finally, a mixture of n-propyl bromide, terpenes and low boiling solvents is known for use in cleaning in vapor degreasers.

The brominated hydrocarbon mixtures all have flash points when tested on open cup type flash point testing machines, and although many of the prior art compositions were described as non-flammable, many of them will combust and/or propagate a flame in open air. Prior art descriptions of no flash point are correct but many of the citations refer to closed cup flash point methods which comply with DOT regulations for shipping of products in closed containers and/or drums. However in commercial practice closed cup flash points are not relevant since the described mixtures are used in open vapor degreasers, tanks, baths, or are used in sprays, wipes or other cleaning methods that are open to the air.

In addition, no indications were made in the prior art as to azeotrope-like behavior of the mixtures. Mixtures that exhibit the non-azeotrope and flash point character are less desirable, and are limited in actual use since they will not effectively operate for extended periods of time in vapor degreasing machines. Azeotrope-like behavior is desirable in vapor degreasing and in most applications since the cleaning/solvent mixture will remain constant and can be redistilled and reused, or used in final rinse cleaning.

### SUMMARY OF THE INVENTION

It is a primary object of the present invention to provide a solvent mixture which can be used in solvating, vapor degreasing, photoresist stripping, adhesive removal, aerosol, cold cleaning, and solvent cleaning applications including defluxing, drycleaning, degreasing, particle removal, metal and textile cleaning and which is free of the aforementioned and other such disadvantages.

It is another object of the present invention to provide a solvent mixture of the type described which is a suitable replacement for ozone-depleting solvents.

It is still another object of the present invention to provide a solvent mixture of the type described which is a suitable replacement for toxic solvents.

It is yet another object of the present invention to provide a solvent mixture of the type described which is a suitable replacement for solvents with low flash points.

The present invention provides a solvent mixture which can be used in solvating, vapor degreasing, photoresist stripping, adhesive removal, aerosol, cold cleaning, and solvent cleaning applications including defluxing, drycleaning, degreasing, particle removal, metal and textile cleaning. The soils and contaminants that are removed in the present invention but are not limited to are oil, grease, coatings, flux, resins, waxes, rosin, adhesives, dirt, fingerprints, epoxies, polymers, and other common contaminants found in the art.

The present cleaning and solvating mixtures comprise mono brominated compounds with highly fluorinated compounds and/or other enhancement agents that improve and enhance the properties of the original mixture. The addition of these agents to the composition will modify the physical and/or cleaning characteristics of the monobrominated compound and/or monobrominated compound-fluorinated compound mixture to accomplish its desired cleaning or solvating task. The enhancement agents are one or more of the following materials: alcohols, esters, ethers, cyclic ethers, ketones, alkanes, terpenes, dibasic esters, glycol ethers, pyrollidones, or low or non ozone depleting chlorinated and chlorinated/fluorinated hydrocarbons. These mixtures are useful in a variety of solvating, vapor degreasing, photoresist stripping, adhesive removal, aerosol, cold cleaning, and solvent cleaning applications including defluxing, dry cleaning, degreasing, particle removal, metal and textile cleaning. In particular, the mono brominated compounds with highly fluorinated compounds and/or other enhancement agents can be used to replace highly ozone depleting materials such as chlorofluorocarbons (CFC), methyl chloroform, hydrochlorofluorocarbons (HCFC) or chlorinated solvents.

In the novel cleaning compositions of the present invention, monobrominated compounds of the formula CₓH₂ₓ₊₁Br where x is 2-12 and C_{y}H_{2y-1}Br where y is 2-12 can be used. Fluorinated compounds of the formula CₐF_{b}H_{c}X_{d} where a is 1-16, b>c, c can be 1-16, d can be 0 or greater and X can be O, N, halogen, or Si, in any possible combination as long as the number of F atoms exceeds the number of H atoms in the molecule, can be used. Throughout this specification and claims, by “halogen” is meant Cl, Br, and I. Other materials that can be added are one or more of the following materials: alcohols, esters, ethers, cyclic ethers, ketones, alkanes, terpenes, dibasic esters, glycol ethers, pyrollidones, or low or non ozone depleting chlorinated and chlorinated/fluorinated hydrocarbons. The addition of the fluorinated compounds to the mixture will reduce and/or eliminate the flammability measured as the closed or open cup flash points of the mixture. In addition the proper selection of the materials in the mixture may create an azeotrope or azeotrope-like blend which is desirable. Furthermore, those skilled in the art would be aware of other additives such as surfactants, colorants, dyes, fragrances, indicators,-inhibitors, and buffers as well as other ingredients which modify the properties of the mixture.

The brominated component of the mixture disclosed above contains effective amounts of the brominated material of the form CₓH₂ₓ₊₁Br where x is 2-12, preferably 3 to 8, more preferably 3 to 6. Examples of the suitable brominated materials represented by this formula include, bromoethane, 1-bromopropane, 2-bromopropane, 1-bromobutane, 2-bromobutane, bromomethylpropane, 1-bromopentane, 2-bromopentane, 3-bromopentane, bromomethylbutane, bromocyclopentane, 1-bromohexane, 2-bromohexane, 3-bromohexane, bromomethylpentane, bromoethylbutane, bromocyclohexane, bromoheptane, bromooctane, bromononane, bromodecane and ethylhexyl bromide. They are usable either singly or as a mixture of two or more. Among the most preferred are 1-bromopropane, and 2-bromopropane.

The fluorinated component of the mixture is of the formula CₐF_{b}H_{c}X_{d} where a is 1-16, preferably 2 to 8, more preferably 3 to 7, b>c, c is 1 to 16, preferably 1 to 5, more preferably 1 to 3, d can be 0 or greater and X can be O, N, halogen, or Si, in any possible combination as long as the number of F atoms exceeds the number of H atoms in the molecule, can be used. Examples of suitable fluorinated materials are trifluoromethane, perfluoromethane, tetrafluoroethane, pentafluoroethane, perfluoroethane, pentafluoropropane, hexafluoropropane, heptafluoropropane, perfluoropropane, hexafluorobutane, heptafluorobutane, octafluorobutane, nonafluorobutane, perfluorobutane, heptafluoropentane, octafluoropentane, nonafluoropentane, decafluoropentane, undecafluoropentane, perfluoropentane, octafluorohexane, nonafluorohexane, decafluorohexane, undecafluorohexane, dodecafluorohexane, tridecafluorohexane, and perfluorohexane. Other commercially available fluorinated compounds are: 3-chloro-1,1,1-trifluoropropane (HCFC-253fb); 1,1,1,3,3,5,5,5-octafluoropentane (HFC-458mfcf); 4-trifluoromethyl-1,1,1,2,2,3,3,5,5,5-decafluoropentane (HFC-52-13); 4-trifluoromethyl-1,1,1,2,2,5,5,5-octafluoropentane (HFC-54-11); 4-trifluoromethyl-1,1,1,2,2,3,5,5,5-nonafluoropentane (HFC-53-12); 1,1,1,2,3,4,4,5,5,5-decafluoropentane (HFC-43-10mee); 1,1,1,2,2,3,3,4,4,5,6-undecafluorohexane (HFC-54-11qe); 1,1,2,2,3,3,4,4-octafluorobutane (HFC-338 pcc); 1,1,1,2,2,3,3,4,4-nonafluorobutane-4-methyl ether (HFE-7100); 1,1,1,2,2,3,4,4,4-nonafluoroisobutane-3-methyl ether (HFE-7100); 1,1,1,2,2,3,3,4,4-nonafluorobutane-4-ethyl ether (HFE-7200); 1,1,1,2,2,3,4,4,4-nonafluoroisobutane-3-ethyl ether (HFE-7200); 1,1,2,2,3,3,4,5-octafluorocyclopentane; pentafluoroethane (HFC-134); dichloro-trifluoroethane (HCFC-123); trichloro-tetrafluoropropane (HCFC-224); dichloro-pentafluoropropane (HCFC-225); dichloro-tetrafluoropropane (HCFC-234); chloro-pentafluoropropane (HCFC-235); chloro-tetrafluoropropane (HCFC-244); chloro-hexafluoropropane (HCFC-226); pentachloro-difluoropropane (HCFC-222); tetrachloro-trifluoropropane (HCFC-223); trichloro-trifluoropropane (HCFC-233) pentafluoropropane (HFC-245) and nonafluorobutylethylene (PFBET). They can be used either singly or as a mixture of two or more.

Among the most preferred are HFE-7100, HFC 43-10, HCFC-225, PFBET, HCFC-123, and octafluorocyclopentane.

Other compounds may be added to the mixture to vary the properties of the cleaner or solvent to fit various applications. The addition of these other compounds may also assist in the formation of useful azeotropic compositions. An azeotropic composition is defined as a constant boiling mixture of two or more substances that behaves like a single substance. Azeotropic compositions are desirable because they do not fractionate upon boiling. This behavior is desirable because mixtures may be used in vapor degreasing equipment and or the material may be redistilled.

Since achieving a perfect azeotrope is not practical in industrial use, all mixtures are described as “azeotrope-like”. The term “azeotrope-like composition” means a constant boiling, or substantially constant boiling mixture of two or more substances that behave as a single substance, which therefore can distill without substantial compositional change. Constant boiling compositions, which are characterized as “azeotrope-like” will exhibit either a maximum, or minimum boiling point compared to non azeotropic mixtures of two substances.

As used herein, the terms azeotrope, azeotrope-like and constant boiling are intended to mean also essentially azeotropic or essentially constant boiling. In other words, included within the meaning of these terms is not only the true azeotropes, but also other compositions containing the same components in different proportions, which are true azeotropes or are constant boiling at other temperature and pressure. As is well recognized in this art, there is a range of compositions which contain the same components as the azeotrope, which will not exhibit essentially equivalent properties for cleaning, solvating and other applications, but will exhibit essentially equivalent properties as the true azeotropic composition in terms of constant boiling characteristics or tendency not to separate or fractionate on boiling.

The alcohol component of the mixture is of the formula CₓH_{y}(OH)_{z} where x is 1 to 12, preferably 1 to 8, more preferably 1 to 6, y<2x+2 and z is 1 or 2. Examples of these alcohols are methyl alcohol, ethyl alcohol, propyl alcohol, isopropyl alcohol, n-butyl alcohol, 2-butyl alcohol, t-butyl alcohol, 1-pentanol, 2-pentanol, 3-pentanol, trifluoroethanol, allyl alcohol, 1-hexanol, 2-hexanol, 3-hexanol, 2-ethyl hexanol, 1-octanol, 1-decanol, 1-dodecanol, cyclohexanol, cyclopentanol, benzyl alcohol, furfuryl alcohol, tetrahydrofurfuryl alcohol, bis-hydroxymethyl tetrahydrofuran, ethylene glycol, propylene glycol, and butylene glycol. They can be used either singly or in the form of a mixture of two or more. Among the most preferred are methanol, ethanol, isopropanol, tert butyl alcohol.

The ester component of the mixture is of the formula R₁—COO—R₂ where R₁ and R₂ could be the same or different, R₁ is C₁-C₂₀ alkyl, C₅-C₆ cycloalkyl, benzyl, furanyl or tetrahydrofuranyl, preferably C₁ to C₈ alkyl, more preferably C₁ to C₄ alkyl; R₂ is C₁-C₈ alkyl, preferably C₁ to C₄ alkyl, C₅-C₆ cycloalkyl, benzyl, phenyl, furanyl or tetrahydrofuranyl. Examples of these esters are methyl formate, methyl acetate, methyl propionate, methyl butyrate, ethyl formate, ethyl acetate, ethyl propionate, ethyl butyrate, propyl formate, propyl acetate, propyl propionate, propyl butyrate, butyl formate, butyl acetate, butyl propionate, butyl butyrate, methyl soyate, isopropyl myristate, propyl myristate, and butyl myristate. Among the most preferred are methyl formate, methyl acetate, ethyl acetate and ethyl formate.

The ether component of the mixture is of the formula R₃—O—R₄ where R₃ is C₁-C₁₀ alkyl or alkynl, C₅-C₆ cycloalkyl, benzyl, phenyl, furanyl or tetrahydrofuranyl, R₄ is C₁-C₁₀ alkyl or alkynyl, C₅-C₆ cycloalkyl, benzyl, phenyl, furanyl or tetrahydrofuranyl. Examples of these ethers are ethyl ether, methyl ether, propyl ether, isopropyl ether, butyl ether, methyl tert butyl ether, ethyl tert buytl ether, vinyl ether, allyl ether and anisole. In the composition listed R₃ and R₄, which can be the same or different, can be C₁ to C₁₀ alkyl or alkynyl, preferably C₁ to C₆ alkyl or alkynyl, more preferably C₁ to C₄ alkyl. Among the most preferred are isopropyl ether and propyl ether.

The preferred cyclic ethers for the mixture are: 1,4-dioxane, 1,3-dioxolane tetrahydrofuran (THF), methyl THF, dimethyl THF and tetrahydropyran (THP), methyl THP, dimethyl THP, ethylene oxide, propylene oxide, butylene oxide, amyl oxide, and isoamyl oxide.

The ketone component of the mixture is of the formula: R₅—C═O—R₆ where R₅ is C₁-C₁₀ alkyl, C₅-C₆ cycloalkyl, benzyl, furanyl or tetrahydrofuranyl, R₆ is C₁-C₁₀ alkyl, C₅-C₆ cycloalkyl, benzyl, phenyl, furanyl or tetrahydrofuranyl. Examples of these ketones are acetone, methyl ethyl ketone, 2-pentanone, 3-pentanone, 2-hexanone, 3-hexanone, and methyl isobutyl ketone. In the composition R₅ and R₆, which can be the same or different, can be C₁ to C₁₀ alkyl, preferably C₁ to C₆ alkyl or alkynyl, more preferably C₁ to C₄ alkyl. Among the most preferred are acetone, methyl ethyl ketone, 3-pentanone and methyl isobutyl ketone.

The alkane component of the mixture is of the formula: CₙHₙ₊₂ where n is 1-20, or C₄-C₂₀ cycloalkanes. Examples of these alkanes are methane, ethane, propane, butane, methyl propane, pentane, isopentane, methyl butane, cyclopentane, hexane, cyclohexane, isohexane, heptane, methyl pentane, dimethyl butane, octane, nonane and decane. In the composition, x can be 1 to 20, preferably 4 to 9, more preferably 5 to 7. Among the most preferred are cyclopentane, cyclohexane, hexane, methyl pentane, and dimethyl butane.

The terpene component of the mixture contains at least one isoprene group of the general formula:

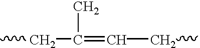

The molecule may be cyclic or multicyclic. Preferred examples are d-limonene, pinene, terpinol, terpentine and dipentene.

The dibasic ester component of the mixture is of the formula: R₇—COO—R₈—COO—R₉ where R₇ is C₁-C₂₀ alkyl, C₅-C₆ cycloalkyl, benzyl, furanyl or tetrahydrofuranyl, R₈ is C₁-C₂₀ alkyl, C₅-C₅ cycloalkyl, benzyl, phenyl, furanyl or tetrahydrofuranyl, R₉ is C₁-C₂₀ alkyl, C₅-C₆ cycloalkyl, benzyl, furanyl or tetrahydrofuranyl. Examples of these dibasic esters are dimethyl oxalate, dimethyl malonate, dimethyl succinate, dimethyl glutarate, dimethyl adipate, methyl ethyl succinate, methyl ethyl adipate, diethyl succinate, diethyl adipate. In the formula, R₇, R₈, and R₉, which can be the same or different, can be C₁ to C₂₀ alkyl, preferably C₁ to C₆ alkyl or alkynyl, more preferably C₁ to C₄ alkyl. Among the most preferred are dimethyl succinate, and dimethyl adipate.

The glycol ether component of the mixture is of the formula: R₁₀—O—R₁₁—O—R₁₂ where R₁₀ is C₂-C₂₀ alkyl, C₅-C₆ cycloalkyl, benzyl, furanyl or tetrahydrofuranyl, R₁₁ is C₁-C₂₀ alkyl, C₅-C₆ cycloalkyl, benzyl, phenyl, furanyl or tetrahydrofuranyl, R₁₂ is hydrogen or an alcohol as defined above. Examples of these glycol ethers are ethylene glycol methyl ether, diethylene glycol methyl ether, ethylene glycol ethyl ether, diethylene glycol ethyl ether, ethylene glycol propyl ether, diethylene glycol propyl ether, ethylene glycol butyl ether, diethylene glycol butyl ether, propylene glycol methyl ether, dipropylene glycol, dipropylene glycol methyl ether, propylene glycol propyl ether, dipropylene glycol propyl ether, methyl methoxybutanol, propylene glycol butyl ether, and dipropylene glycol butyl ether. R₁₀, R₁₁, and R₁₂, which can be the same or different, can be C₁ to C₁₀ alkyl, preferably C₁ to C₆ alkyl, more preferably C₁ to C₄alkyl. Among the most preferred are propylene glycol butyl ether, dipropylene glycol methyl ether, dipropylene glycol, methyl methoxybutanol, and diethylene glycol butyl ether.

The pyrrolidone component of the mixture is substituted in the N position of the pyrrolidone ring by hydrogen, C₁ to C₆ alkyl, or C₁ to C₆ alkanol. Examples of these pyrrolidones are pyrrolidone, N-methyl pyrrolidone, N-ethyl pyrrolidone, N-propyl pyrrolidone, N-hydroxymethyl pyrrolidone, N-hydroxyethyl pyrrolidone, and N-hexyl pyrrolidone. Among the most preferred are N-methyl pyrrolidone and N-ethyl pyrrolidone.

The chlorinated hydrocarbon component is of the formula: R₁₃—Cl_{X} where R₁₃ is C₁-C₂₀ alkyl, C₄-C₁₀ cycloalkyl, C₂-C₂₀ alkenyl benzyl, phenyl, fluoroethyl, and X>0, and the Ozone Depletion Potential (ODP) of the molecule<0.15. Examples of these chlorinated materials are methyl chloride, methylene chloride, ethyl chloride, dichloro ethane, dichloro ethylene, propyl chloride, isopropyl chloride, propyl dichloride, butyl chloride, isobutyl chloride, sec-butyl chloride, tert-butyl chloride, pentyl chloride, hexyl chloride, and dichlorofluoro ethane (HCFC-141).

The described mixtures are intended to be used in a similar manner as CFC's and chlorinated solvents, which have been widely used in the past in cleaning applications. These mixtures may be used in various techniques of cleaning which would be apparent to one skilled in the art such as spraying, spray under immersion, vapor degreasing/cleaning, immersion, wiping with cloths and brushes, immersion with ultrasonics, immersion with tumbling and spraying into air. These techniques were used to clean hard surfaces of items and were also used to clean textiles.

The described mixtures are also intended to be used in a similar manner as CFC's and chlorinated solvents, which have been widely used in past solvating applications. These mixtures may be used as a solvent in adhesives, paints, chemical processes, and other applications in which the solubility parameter of the solvent dissolved the solid or liquid, and/or exhibited appropriate volatility for the application.

The key to the success of these mixtures as solvents and cleaning agents is the fact that some of these mixtures may be formulated to have no flash point. This is important because it allows the solvent to be used safely without the threat of flammability as was found in similar solvents which had the same volatility.

### DESCRIPTION OF THE PREFERRED EMBODIMENTS

In accordance with the invention, novel compositions have been formulated comprising of one or more brominated hydrocarbons combined with one or more other agents.

The resultant composition can be formulated to have acceptable low ozone depletion potential, and will have some or all of the similar desirable characteristics of CFC's and chlorinated solvents of: cleaning ability, compatibility, volatility, viscosity, solvating ability, drying ability, low or no VOC, and/or surface tension character. In addition some blends will exhibit no flash points in keeping in character with the CFC and chlorinated based solvents.

The content of the enhancement components in the mixture of the present invention is not particularly limited, but for the addition of an effective amount necessary to improve or control solubility, volatility, boiling point, flammability, surface tension, viscosity, reactivity, and material compatibility. Preferably such incorporation of materials will bring about an azeotrope or an azeotrope-like mixture.

As used in this specification and claims, effective amounts for azeotropes is defined as the amount of each component of the inventive compositions that, when combined, results in the formation of an azeotropic or azeotrope-like composition. This definition includes the amounts of each component, which amounts vary depending on the pressure applied to the composition, so long as the azeotropic or azeotrope-like, or constant boiling or substantially constant boiling compositions continue to exist at different pressures, but with possible different boiling points. Therefore, effective amount includes the weight percentage of each component of the composition of the instant invention, which forms azeotropic or azeotrope-like, or constant boiling or substantially constant boiling, compositions at pressures other than atmospheric pressure.

It is possible to characterize, in effect, a constant boiling mixture, which may appear under many guises, depending on the conditions chosen, by any of several criteria:

A composition can be defined as an azeotrope of A, B, and C, since the term “azeotrope” is at once both definitive and limitative, and requires that effective amounts of A, B, and C form this unique composition of matter, which is a constant boiling mixture.

It is well known by those skilled in the art that at different pressures, the composition of a given azeotrope will vary, at least to some degree, and changes in pressure will also change, at least to some degree, the boiling point. Thus an azeotrope of A, B, and C represents a unique type of relationship but with a variable composition which depends on temperature and/or pressure. Therefore compositional ranges rather than fixed compositions are often used to describe azeotropes.

The composition can be defined as a particular weight percent relationship or mole percent relationship of A, B, and C, while recognizing that such specific values point out only one particular such relationship and that in actuality, a series of such relationships, represented by A, B, and C actually exist for a given azeotrope, varied by the influence of pressure.

Azeotrope A, B, and C can be characterized by defining the composition as an azeotrope characterized by a boiling point at a given pressure, thus giving identifying characteristics without unduly limiting the scope of the invention by a specific numerical composition which is limited by and is only as accurate as the analytical equipment available.

The following binary compositions are characterized as azeotropic or azeotrope-like in that compositions within these ranges exhibit substantially constant boiling point at constant pressure. Being substantially constant boiling, the compositions do not tend to fractionate to any great extent upon evaporation at standard conditions. After evaporation, only a small difference exists between the composition of the vapor and the composition of the initial liquid phase. This difference is such that the composition of the vapor and liquid phases are considered substantially the same and are azeotropic or azeotrope like in their behavior.

1) 15-35 weight percent n-propyl bromide (NPB) and 65-85 weight percent nonafluorobutane methyl ether (HFE-7100).

2) 13-33 weight percent NPB and 67-87 weight percent 1,1,1,2,3,4,4,5,5,5-decafluoropentane (HFC-43-10mee).

3) 70-90 weight percent NPB and 10 to 30 weight percent 1,3-dioxolane.

4) 14-34 weight percent NPB and 66-86 weight percent acetone.

5) 75-95 weight percent NPB and 5-25 weight percent isopropyl alcohol.

6) 69-89 weight percent NPB and 11-31 weight percent methanol.

7) 85-99 weight percent NPB and 1-15 weight percent n-propyl alcohol.

8) 74-94 weight percent NPB and 6-26 weight percent t-butyl alcohol.

9) 15-35 weight percent NPB and 65-85 weight percent nonafluorobutylethylene (PFBET).

10) 93-73 weight percent NPB and 7-27 weight percent ethanol.

11) 0.1-10 weight percent 2-bromopropane and 99.9-90 weight percent trifluoro dichloro ethan (HCFC-123).

12) 81-99 weight percent NPB and 1-81 weight percent allyl alcohol.

13) 70-90 weight percent NPB and 10-30 weight percent ethyl acetate.

14) 35-55 weight percent NPB and 45-65 weight percent propyl formate.

15) 84-99.9 weight percent NPB and 0.1-16 weight percent nitromethane.

The following binary compositions have been established, within the accuracy of successive distillation methods, as true binary azeotropes at substantially atmospheric pressure.

1) 25 weight percent NPB and 75 weight percent HFE-7100, boiling point of about 135° F. (about 57° C.).

2) 23 weight percent NPB and 77 weight percent HFC-43-10mee, boiling point of about 126° F. (about 52° C.).

3) 79.5 weight percent NPB and 20.5 weight percent 1,3 dioxolane, boiling point of about 162° F. (about 72° C.).

4) 24 weight percent NPB and 76 weight percent acetone, boiling point of about 134° F. (about 57° C.).

5) 85 weight percent NPB and 15 weight percent isopropyl alcohol, boiling point of about 154° F. (about 68° C.).

6) 79 weight percent NPB and 21 weight percent methanol, boiling point of about 135° F. (about 57° C.).

7) 95 weight percent NPB and 5 weight percent n-propyl alcohol, boiling point of about 158° F. (about 70° C.).

8) 84 weight percent NPB and 16 weight percent t-butyl alcohol boiling point of about 154° F. (about 68° C.).

9) 25 weight percent NPB and 75 weight percent PFBET boiling point of about 131° F. (about 55° C.).

10) 84 weight percent NPB and 16 weight percent ethanol boiling at about 147° F. (about 64° C.).

11) 98 weight percent 2-bromopropane and 2 weight percent HCFC-123 boiling at about 88° F. (about 31° C.).

12) 91 weight percent NPB and 9 weight percent allyl alcohol boiling at about 157° F. (about 69° C.).

13) 80 weight percent NPB and 20 weight percent ethyl acetate boiling at about 159° F. (about 71° C.).

14) 45 weight percent NPB and 55 weight percent propyl formate boiling at about 151° F. (about 66° C.).

15) 94 weight percent NPB and 6 weight percent nitromethane boiling at about 158° F. (about 70° C.).

The following tertiary compositions are characterized as azeotropic or azeotrope-like in that compositions within these ranges exhibit substantially constant boiling point at constant pressure. Being substantially constant boiling, the compositions do not tend to fractionate to any great extent upon evaporation. After evaporation, only a small difference exists between the composition of the vapor and the composition of the initial liquid phase. This difference is such that the composition of the vapor and liquid phases are considered substantially the same and are azeotropic or azeotrope like in their behavior.

1) 18-38 weight percent isopropyl bromide (IPB), 48-68 weight percent nonafluorobutane methyl ether (HFE-7100) and 3-23 weight percent acetone.

2) 10-30 weight percent n-propyl bromide (NPB), 60-80 weight percent nonafluorobutane methyl ether (HFE-7100) and 10-30 weight percent acetone.

3) 17-37 weight percent n-propyl bromide (NPB), 66-86 weight percent nonafluorobutane methyl ether (HFE-7100) and 0.1-14 weight percent methanol.

4) 7-27 weight percent n-propyl bromide (NPB), 56-76 weight percent nonafluorobutane methyl ether (HFE-7100) and 7-27 weight percent methyl acetate.

5) 3-23 weight percent n-propyl bromide (NPB), 69-89 weight percent nonafluorobutane methyl ether (HFE-7100) and 1-17 weight percent tetrahydrofuran.

6) 11-31 weight percent n-propyl bromide (NPB), 65-85 weight percent nonafluorobutane methyl ether (HFE-7100) and 1-14 weight percent isopropyl alcohol.

7) 30-50 weight percent n-propyl bromide (NPB), 34-54 weight percent nonafluorobutane methyl ether (HFE-7100) and 30-50 weight percent cyclopentane.

8) 7-27 weight percent n-propyl bromide (NPB), 66-86 weight percent 1,1,1,2,3,4,4,5,5,5-decafluoropentane (HFC-43-10mee), and 7-27 weight percent methanol.

9) 2-22 weight percent n-propyl bromide (NPB), 77-97 weight percent 1,1,1,2,3,4,4,5,5,5-decafluoropentane (HFC-43-10mee), and 1-12 weight percent isopropanol.

10) x-xx weight percent n-propyl bromide (NPB), XX-XX weight percent nonafluorobutane methyl ether (HFE-7100) and zz to zz weight percent 1-propanol.

11) 9-29 weight percent n-propyl bromide (NPB), 66-86 weight percent nonafluorobutane methyl ether (HFE-7100) and zz0.1-14 weight percent ethanol.

12) 0.1-18 weight percent NPB, 37-57 weight percent nonafluorobutane methyl ether (HFE-7100), and 35-55 weight percent 1,2-trans-dichloroethylene.

13) 25-45 weight percent NPB, 45-65 weight percent 1,1,1,2,3,4,4,5,5,5-decfluoropentane (HFC 43-10mee), and 0.1-20 weight percent acetone.

14) 5-25 weight percent NPB, 69-89 weight percent nonafluorobutylethylene (PFBET), and 0.1-18 weight percent methanol.

The following ternary compositions have been established, within the accuracy of successive distillation methods, as true ternary azeotropes at substantially atmospheric pressure.

1) 28.5 weight percent isopropyl bromide (IPB), 58.0 weight percent nonafluorobutane methyl ether (HFE-7100) and 13.5 weight percent acetone, boiling point of about 124° F. (about 51° C.).

2) 9.5 weight percent n-propyl bromide (NPB), 70.0 weight percent nonafluorobutane methyl ether (HFE-7100) and 20.5 weight percent acetone, boiling point of about 127° F. (about 53° C.).

3) 16.9 weight percent n-propyl bromide (NPB), 75.6 weight percent nonafluorobutane methyl ether (HFE-7100) and 7.5 weight percent methanol, boiling point of about 116° F. (about 47° C.).

4) 16.3 weight percent n-propyl bromide (NPB), 66.4 weight percent nonafluorobutane methyl ether (HFE-7100) and 17.3 weight percent methyl acetate, boiling point of about 130° F. (about 54° C.).

5) 13.0 weight percent n-propyl bromide (NPB), 79.4 weight percent nonafluorobutane methyl ether (HFE-7100) and 7.6 weight percent tetrahydrofuran, boiling point of about 137° F. (about 58° C.).

6) 21.1 weight percent n-propyl bromide (NPB), 75.0 weight percent nonafluorobutane methyl ether (HFE-7100) and 3.9 weight percent isopropyl alcohol, boiling point of about 131° F. (about 55° C.).

7) 39.9 weight percent n-propyl bromide (NPB); 44.6 weight percent nonafluorobutane methyl ether (HFE-7100) and 15.6 weight percent cyclopentane, boiling point of about 110° F. (about 43° C.).

8) 16.5 weight percent n-propyl bromide (NPB), 76.0 weight percent 1,1,1,2,3,4,4,5,5,5-decafluoropentane (HFC-43-10mee), and 7.5 weight percent methanol, boiling point of about 116° F. (about 47° C.).

9) 11.4 weight percent n-propyl bromide (NPB), 87.3 weight percent 1,1,1,2,3,4,4,5,5,5-decafluoropentane (HFC-43-10mee), and 1.3 weight percent isopropanol, boiling point of about 127° F. (about 53° C.).

10) 19.3 weight percent n-propyl bromide (NPB), 76.4 weight percent nonafluorobutane methyl ether (HFE-7100) and 4.3 weight percent 1,3-dioxolane boiling point of about 133° F. (about 56° C.).

11) 20.2 weight percent n-propyl bromide (NPB), 75.5 weight percent nonafluorobutane methyl ether (HFE-7100) and 4.3 weight percent ethanol, boiling point of about 122° F. (about 50° C.).

12) 8 weight percent NPB, 47 weight percent nonafluorobutane methyl ether (HFE-7100), and 45 weight percent 1,2-trans-dichloroethylene, boiling at about 116° F. (about 47° C.).

13) 35 weight percent NPB, 55 weight percent 1,1,1,2,3,4,4,5,5,5-decafluoropropane (HFC 43-10mee), and 10 weight percent acetone boiling at about 128° F. (about 53° C.).

14) 15 weight percent NPB, 79 weight percent monofluorobutylethylene (PFBET), and 8 weight percent methanol boiling at about 113° F. (about 45° C.).

It is Preferred that inhibitors be added to the compositions to inhibit decomposition, react with undesirable decomposition products of the compositions, and/or prevent corrosion of metal surfaces. Any and all of the following classes of inhibitors may be employed in the invention, some of which may serve a dual purpose as suitable components for cleaning and solvating. Preferred are alkanols having 4 to 7 carbon atoms, nitroalkanes having 1 to 3 carbon atoms, 1,2 epoxyalkanes having 2 to 7 carbon atoms, acetylene alcohols having 3 to 9 carbon atoms, phosphite esters having 12 to 30 carbon atoms, ethers having 3 to 6 carbon atoms, unsaturated hydrocarbon compounds having 4 to 7 carbon atoms, triazoles, acetals having 4 to 7 carbon atoms, ketones having 3 to 5 carbon atoms, and amines having 6 to 8 carbon atoms. Other suitable inhibitors will be readily apparent to those skilled in the art.

Inhibitors may be used alone or in mixtures in any proportions. Typically less than 5 weight percent and, preferably, less than 2 weight percent of inhibitor based on the total weight of the mixture may be used.

In addition the composition of the present invention may further contain surfactants, emulsifying agents, wetting agents, water, perfumes, indicators, or colorants.

The compositions of the invention are useful for solvating, vapor degreasing, photoresist stripping, adhesive removal, aerosol, cold cleaning, and solvent cleaning applications including defluxing, dry cleaning, degreasing, particle removal, metal and textile cleaning.

### EXAMPLES 1-28

The azeotropic mixtures of this invention were initially identified by screening mixtures of monobrominated hydrocarbons and various organic solvents including the fluorinated solvents mentioned earlier. The selected mixtures were distilled in a Kontes multistage distillation apparatus using a Snyder distillation column. The distilled overhead composition was analyzed using a Hewlett-Packard Gas Chromatograph using a FID detector and a HP-4 column. The overhead composition was compared to the feed composition to identify the azeotropic composition. If the feed and overhead compositions differed then the overhead material was collected and re-distilled until successive distillation compositions were within 1% of the feed composition, indicating an azeotrope. The method was also supplemented by recording temperatures of the feed at boiling. The presence of an azeotrope was also indicated when the test mixture exhibited a lower boiling point than the boiling point of the subsequent feed mixture. Results obtained are summarized in Table 1.

TABLE 1
Azeotrope Compositions

| | | | | | | | Azeotrope | |
|---|---|---|---|---|---|---|---|---|
| | Monobrominated | Fluorinated | | Weight Percent | Weight Percent | Weight Percent | Boiling Point | Flash |
| Example | Material | Material | Other Material | Mono-brominated | Fluorinated | Other Material | ° F./° C. | Point |
| 1 | 1-Bromopropane | HFE-7100 | | 25.0% | 75.0% | | 135/57 | None |
| 2 | 1-Bromopropane | HFC-4310 | | 23.0% | 77.0% | | 126/52 | None |
| 3 | 1-Bromopropane | PFBET | | 25.0% | 75.0% | | 131/55 | None |
| 4 | 1-Bromopropane | | 1-Propanol | 95.0% | | 5.0% | 158/70 | Yes |
| 5 | 1-Bromopropane | | 2-Propanol | 85.2% | | 14.8% | 154/68 | Yes |
| 6 | 1-Bromopropane | | Methanol | 79.0% | | 21.0% | 135/57 | Yes |
| 7 | 1-Bromopropane | | Ethanol | 83.8% | | 16.2% | 147/64 | Yes |
| 8 | 1-Bromopropane | | t-Butanol | 84.0% | | 16.0% | 158/70 | Yes |
| 9 | 1-Bromopropane | | Acetone | 24.0% | | 76.0% | 128/53 | Yes |
| 10 | 1-Bromopropane | | 1,3-Dioxolane | 79.5% | | 20.5% | 134 | Yes |
| 11 | 2-Bromopropane | CHFC-123 | | 98.2% | | 88.0% | None | Yes |
| 12 | 1-Bromopropane | HFE-7100 | Acetone | 9.5% | 70.0% | 20.5% | 127/53 | Yes |
| 13 | 1-Bromopropane | | Allyl alcohol | 91.0 | | 9.0 | 157/69 | Yes |
| 14 | 1-Bromopropane | | Ethyl acetate | 80.0 | | 20.0 | 159/71 | Yes |
| 15 | 1-Bromopropane | | Propyl formate | 45.0 | | 55.0 | 151/66 | Yes |
| 16 | 1-Bromopropane | | Nitromethane | 94.0 | | 4.0 | 158/70 | Yes |
| 17 | 1-Bromopropane | HFC-4310 | Acetone | 35.0 | 55.0 | 10.0 | 128/53 | Yes |
| 18 | 1-Bromopropane | PFBET | Methanol | 15.0 | 77.0 | 8.0 | 113/45 | Yes |
| 19 | 2-Bromopropane | HFE-7100 | Acetone | 28.5% | 58.0% | 13.5% | 124/51 | Yes |
| 20 | 1-Bromopropane | HFE-7100 | Methanol | 16.9% | 75.6% | 7.5% | 116/47 | None |
| 21 | 1-Bromopropane | HFE-7100 | Ethanol | 20.2% | 75.5% | 4.3% | 122/50 | No |
| 22 | 1-Bromopropane | HFE-7100 | Cyclopentane | 39.9% | 44.6% | 15.6% | 110/43 | Yes |
| 23 | 1-Bromopropane | HFE-7100 | 2-Propanol | 21.1% | 75.0% | 3.9% | 131/55 | None |
| 24 | 1-Bromopropane | HFE-7100 | Methyl Acetate | 16.3% | 66.4% | 17.3% | 130/54 | Yes |
| 25 | 1-Bromopropane | HFE-7100 | Tetrahydrofuran | 13.0% | 79.4% | 7.6% | 137/58 | Yes |
| 26 | 1-Bromopropane | HFE-7100 | 1,3 Dioxolane | 19.3% | 76.4% | 4.3% | 133/56 | Yes |
| 27 | 1-Bromopropane | HFC-4310 | Methanol | 16.5% | 76.0% | 7.5% | 116/47 | Yes |
| 28 | 1-Bromopropane | HFC-4310 | 2-Propanol | 11.4% | 87.3% | 1.3% | 127/53 | Yes |

### EXAMPLES 29-48

Cleaning/solvating compositions given in Table 2 were prepared using binary mixture of selected brominated compounds and selected fluorinated compounds at various compositions. Tests were conducted to determine the cleaning and solvating of the solvent compositions on the following soils and contaminants materials:

Machine oil from a steel coupon

Axle grease from an aluminum coupon

Lipstick on glass coupon

Adhesive on glass coupon

Epoxy Paint on glass coupon

Latex Paint on glass coupon

Beeswax on steel coupon

Rosin Flux type RA Alpha 615 on ceramic circuit

No Clean Flux Kester 244 on ceramic circuit

The substrate (coupon) was prepared a minimum of 1 day in advance of the cleaning test. The samples were immersed in an unagitiated beaker at room-temperature for 3 minutes, then they were removed, allowed to air dry and inspected for any remaining soil residue. The cleaning test was judged on a 1 to 5 scale as follows:

| | |
|---|---|
| 5 | 100% clean |
| 4 | 90-99% clean |
| 3 | 75-89% clean |
| 2 | 50-74% clean |
| 1 | <50% clean |

Below in Table 2 are the results of the cleaning test of mixtures of brominated and fluorinated materials

TABLE 2
Binary Compositions - Cleaning

| | | | | | | | | | | | | | | Kester |
|---|---|---|---|---|---|---|---|---|---|---|---|---|---|---|
| | | | | | | | | | | | | | Alpha | 244 |
| Ex- | | Fluor- | Percent | Percent | | Oil | | | Ad- | Ep- | | | 615 | No |
| am- | Monobrominated | inated | Mono- | Fluor- | Flash Point | on | | Lip- | he- | oxy | Latex | Bees- | RMA | Clean |
| ple | Material | Material | brominated | inated | Open Cup | Steel | Grease | stick | sive | Paint | Paint | wax | Flux | Flux |
| 29 | 1-Bromopropane | HFE-7100 | 80% | 20% | None to Boil | 5 | 5 | 3 | 5 | 3 | 2 | 3 | 5 | 5 |
| 30 | 1-Bromopropane | HFC-4310 | 80% | 20% | None to Boil | 5 | 5 | 5 | 5 | 4 | 2 | 2 | 5 | 5 |
| 31 | 2-Bromopropane | HFE-7100 | 80% | 20% | None to Boil | 5 | 5 | 3 | 4 | 1 | 2 | 1 | 5 | 4 |
| 32 | 2-Bromopropane | HFC-4310 | 80% | 20% | None to Boil | 5 | 5 | 3 | 4 | 1 | 2 | 1 | 5 | 4 |
| 33 | 1-Bromopropane | HCFC-225 | 80% | 20% | None to Boil | 5 | 5 | 2 | 5 | 2 | 2 | 1 | 5 | 5 |
| 34 | 1-Bromopropane | PFBET | 80% | 20% | None to Boil | 5 | 4 | 5 | 4 | 4 | 2 | 1 | 4 | 5 |
| 35 | 2-Bromopropane | PFBET | 80% | 20% | None to Boil | 5 | 3 | 5 | 4 | 1 | 2 | 1 | 2 | 3 |
| 36 | 1-Bromobutane | HFE-7100 | 80% | 20% | None to Boil | 5 | 3 | 3 | 4 | 2 | 2 | 2 | 5 | 5 |
| 37 | 2-Bromobutane | HFE-7100 | 80% | 20% | None to Boil | 5 | 5 | 3 | 5 | 3 | 2 | 3 | 5 | 5 |
| 38 | 1-Bromopentane | HFE-7100 | 80% | 20% | None to Boil | 5 | 4 | 3 | 2 | 2 | 2 | 2 | 5 | 3 |
| 39 | 2-Bromopentane | HFE-7100 | 80% | 20% | None to Boil | 5 | 4 | 2 | 2 | 2 | 2 | 2 | 5 | 3 |
| 40 | 1-Bromopropane | HCFC-225 | 20% | 80% | None to Boil | 5 | 5 | 1 | 5 | 1 | 2 | 1 | 5 | 1 |
| 41 | 1-Bromopropane | HFE-7100 | 20% | 80% | None to Boil | 4 | 1 | 1 | 1 | 1 | 1 | 1 | 2 | 1 |
| 42 | 1-Bromopropane | HFC-4310 | 20% | 80% | None to Boil | 3 | 3 | 2 | 2 | 1 | 3 | 1 | 2 | 2 |
| 43 | 2-Bromopropane | HFE-7100 | 20% | 80% | None to Boil | 4 | 1 | 1 | 1 | 1 | 1 | 1 | 1 | 1 |
| 44 | 2-Bromopropane | HFC-4310 | 20% | 80% | None to Boil | 3 | 2 | 1 | 2 | 1 | 2 | 1 | 2 | 2 |
| 45 | 1-Bromobutane | HFE-7100 | 20% | 80% | None to Boil | 4 | 1 | 1 | 1 | 1 | 1 | 1 | 2 | 2 |
| 46 | 2-Bromobutane | HFE-7100 | 20% | 80% | None to Boil | 4 | 2 | 1 | 2 | 2 | 1 | 1 | 2 | 2 |
| 47 | 1-Bromopentane | HFE-7100 | 20% | 80% | None to Boil | 4 | 1 | 1 | 1 | 1 | 2 | 1 | 1 | 2 |
| 48 | 2-Bromopentane | HFE-7100 | 20% | 80% | None to Boil | 4 | 1 | 1 | 1 | 1 | 2 | 1 | 1 | 2 |

### EXAMPLES 49-80

Cleaning/solvating compositions given in Table 3 were prepared using ternary mixtures of selected brominated compounds, selected fluorinated compounds and selected third components disclosed above at various compositions. Tests were conducted to determine the cleaning and solvating of the solvent mixtures using the same method as previously discussed. The cleaning test was judged on a 1 to 5 scale as follows:

TABLE 3
Ternary Compositions - Cleaning

| | | | | | | | | | | | | | | Alpha | Kester |
|---|---|---|---|---|---|---|---|---|---|---|---|---|---|---|---|
| | | | | Percent | | Percent | | | | | | | | 615 | 244 No |
| | Monobrominated | Fluorinated | | Mono- | Percent | Other | Oil on | | | | Epoxy | Latex | Bees | RMA | Clean |
| Example | Material | Material | Other Material | brominated | Fluorinated | Material | Steel | Grease | Lipstick | Adhesive | Paint | Paint | wax | Flux | Flux |
| 49 | 1-Bromopropane | HFE-7100 | Methanol | 75% | 20% | 5% | 5 | 5 | 5 | 4 | 4 | 3 | 3 | 5 | 5 |
| 50 | 2-Bromopropane | HFE-7100 | Methanol | 75% | 20% | 5% | 5 | 5 | 5 | 5 | 5 | 2 | 4 | 5 | 5 |
| 51 | 1-Bromobutane | HFE-7100 | Methanol | 75% | 20% | 5% | 5 | 5 | 4 | 5 | 2 | 2 | 4 | 5 | 5 |
| 52 | 2-Bromobutane | HFE-7100 | Methanol | 75% | 20% | 5% | 5 | 4 | 2 | 5 | 2 | 2 | 3 | 5 | 5 |
| 53 | 1-Bromopentane | HFE-7100 | Methanol | 75% | 20% | 5% | 5 | 4 | 5 | 5 | 2 | 2 | 3 | 5 | 5 |
| 54 | 2-Bromopentane | HFE-7100 | Methanol | 75% | 20% | 5% | 5 | 5 | 5 | 5 | 2 | 2 | 3 | 5 | 5 |
| 55 | 1-Bromopropane | HFE-7100 | 1-Propanol | 75% | 20% | 5% | 5 | 5 | 4 | 5 | 2 | 2 | 2 | 5 | 5 |
| 56 | 1-Bromopropane | HFE-7100 | 2-Propanol | 75% | 20% | 5% | 5 | 5 | 3 | 5 | 3 | 2 | 2 | 5 | 5 |
| 57 | 1-Bromopropane | HFE-7100 | Cyclohexanol | 75% | 20% | 5% | 5 | 5 | 5 | 5 | 3 | 2 | 2 | 5 | 5 |
| 58 | 1-Bromopropane | HFE-7100 | Tetrahydrofurfuryl Alcohol | 75% | 20% | 5% | 5 | 5 | 3 | 5 | 2 | 2 | 2 | 5 | 5 |
| 59 | 1-Bromopropane | HFE-7100 | Cyclohexane | 75% | 20% | 5% | 5 | 1 | 5 | 5 | 5 | 1 | 2 | 5 | 1 |
| 60 | 1-Bromopropane | HFE-7100 | Heptane | 75% | 20% | 5% | 5 | 5 | 5 | 4 | 2 | 2 | 2 | 5 | 4 |
| 61 | 1-Bromopropane | HFE-7100 | d-Limonene | 75% | 20% | 5% | 5 | 3 | 4 | 5 | 1 | 2 | 2 | 5 | 4 |
| 62 | 1-Bromopropane | HFE-7100 | Methylene Chloride | 75% | 20% | 5% | 5 | 5 | 5 | 5 | 2 | 3 | 3 | 5 | 3 |
| 63 | 1-Bromopropane | HFE-7100 | Methyl Acetate | 75% | 20% | 5% | 5 | 5 | 5 | 5 | 3 | 3 | 4 | 5 | 5 |
| 64 | 1-Bromopropane | HFE-7100 | Methyl Formate | 75% | 20% | 5% | 5 | 5 | 5 | 5 | 1 | 2 | 2 | 5 | 3 |
| 65 | 1-Bromopropane | HFE-7100 | HCFC-225 | 75% | 20% | 5% | 5 | 5 | 5 | 5 | 1 | 2 | 2 | 5 | 4 |
| 66 | 1-Bromopropane | HFE-7100 | 1,2-Transdichloroethylene | 75% | 20% | 5% | 5 | 5 | 5 | 5 | 1 | 3 | 3 | 5 | 4 |
| 67 | 1-Bromopropane | HFE-7100 | Tetrahydrofuran | 75% | 20% | 5% | 5 | 5 | 5 | 5 | 2 | 2 | 2 | 5 | 5 |
| 68 | 1-Bromopropane | HFE-7100 | 1,3 Dioxolane | 75% | 20% | 5% | 5 | 3 | 5 | 5 | 1 | 2 | 2 | 5 | 2 |
| 69 | 1-Bromopropane | HFE-7100 | Dipropylene Glycol | 75% | 20% | 5% | 5 | 5 | 4 | 5 | 2 | 4 | 3 | 5 | 5 |
| 70 | 1-Bromopropane | HFE-7100 | Propylene Glycol Butyl | 75% | 20% | 5% | 5 | 4 | 5 | 5 | 2 | 4 | 1 | 5 | 5 |
| | | | Ether | | | | | | | | | | | | |
| 71 | 1-Bromopropane | HFE-7100 | Dipropylene Glycol Methyl | 75% | 20% | 5% | 5 | 5 | 5 | 5 | 3 | 3 | 3 | 5 | 3 |
| | | | Ether | | | | | | | | | | | | |
| 72 | 1-Bromopropane | HFE-7100 | Diethylene Glycol Butyl | 75% | 20% | 5% | 5 | 5 | 2 | 5 | 3 | 3 | 3 | 5 | 3 |
| | | | Ether | | | | | | | | | | | | |
| 73 | 1-Bromopropane | HFE-7100 | Dipropylene Glycol Methyl | 75% | 20% | 5% | 5 | 5 | 5 | 3 | 2 | 2 | 2 | 5 | 5 |
| | | | Ether Acetate | | | | | | | | | | | | |
| 74 | 1-Bromopropane | HFE-7100 | Mixed (C4-C6) Dibasic | 75% | 20% | 5% | 5 | 4 | 3 | 5 | 1 | 2 | 2 | 5 | 5 |
| | | | Esters | | | | | | | | | | | | |
| 75 | 1-Bromopropane | HFE-7100 | n-Methyl Pyrrolidone | 75% | 20% | 5% | 5 | 4 | 5 | 5 | 2 | 2 | 2 | 5 | 5 |
| 76 | 1-Bromopropane | HFE-7100 | n-Ethyl Pyrrolidone | 75% | 20% | 5% | 5 | 5 | 5 | 5 | 2 | 2 | 2 | 5 | 5 |
| 77 | 1-Bromopropane | HFE-7100 | Methyl Soyate | 75% | 20% | 5% | 5 | 5 | 5 | 5 | 2 | 2 | 2 | 5 | 5 |
| 78 | 1-Bromopropane | HFE-7100 | Isopropyl Ether | 75% | 20% | 5% | 5 | 5 | 5 | 5 | 1 | 3 | 1 | 5 | 5 |
| 79 | 1-Bromopropane | HFE-7100 | Methyl Ethyl Ketone | 75% | 20% | 5% | 5 | 4 | 3 | 5 | 1 | 2 | 2 | 5 | 5 |
| 80 | 1-Bromopropane | HFE-7100 | Acetone | 75% | 20% | 5% | 5 | 4 | 4 | 5 | 4 | 2 | 2 | 5 | 5 |

### EXAMPLES 81-89

Cleaning/solvating compositions given in Table 4 were prepared using binary azeotrope mixtures of selected brominated compounds, and selected fluorinated and or other compounds at the azeotrope composition. Tests were conducted to determine the cleaning and solvating of the solvent mixtures using the same method as previously discussed. The cleaning test was judged on a 1 to 5 scale as follows:

TABLE 4
Binary Azeotrope Compositions - Cleaning

| | | | | | | | | | | | | Alpha | Kester | |
|---|---|---|---|---|---|---|---|---|---|---|---|---|---|---|
| Ex- | | | Percent | | Oil | | | Ad- | | | | 615 | 244 No | Open Cup |
| am- | Monobrominated | Other | Mono- | Percent | on | | Lip- | he- | Epoxy | Latex | Bees | RMA | Clean | Flash |
| ple | Material | Material | brominated | Other | Steel | Grease | stick | sive | Paint | Paint | wax | Flux | Flux | Point |
| 81 | 1-Bromopropane | HFE-7100 | 25% | 75% | 5 | 2 | 1 | 1 | 1 | 1 | 1 | 3 | 2 | None |
| 82 | 1-Bromopropane | HFC-4310 | 23% | 77% | 3 | 2 | 1 | 2 | 1 | 3 | 1 | 2 | 2 | None |
| 83 | 1-Bromopropane | PFBET | 23% | 77% | 4 | 1 | 1 | 1 | 1 | 1 | 1 | 2 | 1 | None |
| 84 | 1-Bromopropane | 1-Propanol | 95% | 5% | 5 | 5 | 5 | 5 | 5 | 3 | 1 | 5 | 5 | Yes |
| 85 | 1-Bromopropane | 2-Propanol | 85% | 15% | 5 | 4 | 5 | 5 | 2 | 3 | 3 | 5 | 5 | Yes |
| 86 | 1-Bromopropane | Methanol | 79% | 21% | 5 | 4 | 3 | 5 | 3 | 3 | 1 | 5 | 5 | Yes |
| 87 | 1-Bromopropane | Ethanol | 84% | 16% | 5 | 5 | 5 | 5 | 5 | 3 | 1 | 5 | 5 | Yes |
| 88 | 1-Bromopropane | t-Butanol | 84% | 16% | 5 | 5 | 5 | 5 | 4 | 3 | 1 | 5 | 5 | Yes |
| 89 | 1-Bromopropane | Acetone | 24% | 76% | 5 | 2 | 1 | 4 | 2 | 2 | 2 | 5 | 5 | Yes |

### EXAMPLES 90-101

Cleaning/solvating compositions given in Table 5 were prepared using ternary azeotropic mixtures of selected brominated compounds, selected fluorinated compounds and selected third components at the disclosed azeotropic composition. Tests were conducted to determine the cleaning and solvating of the solvent mixtures using the same method as previously discussed. The cleaning test was judged on a 1 to 5 scale as follows:

TABLE 6
Ternary Azeotrope Composition - Cleaning

| | Mono- | | | Percent | | | | | | | | | | Alpha | Kester | Open |
|---|---|---|---|---|---|---|---|---|---|---|---|---|---|---|---|---|
| Ex- | bro- | Fluor- | | Mono- | Percent | Percent | Oil | | | Ad- | Ep- | | | 615 | 244 No | Cup |
| am- | minated | inated | Other | bro- | Fluor- | Other | on | | Lip- | he- | oxy | Latex | Bees | RMA | Clean | Flash |
| ple | Material | Material | Material | minated | inated | Material | Steel | Grease | stick | sive | Paint | Paint | wax | Flux | Flux | Point |
| 90 | 1-Bromo- | HFE-7100 | Acetone | 9.5% | 70.0% | 20.5% | 5 | 2 | 1 | 1 | 1 | 1 | 1 | 3 | 2 | Yes |
| | propane | | | | | | | | | | | | | | | |
| 91 | 1-Bromo- | HFE-7100 | Acetone | 28.5% | 58.0% | 13.5% | 3 | 2 | 1 | 2 | 1 | 3 | 1 | 2 | 2 | Yes |
| | propane | | | | | | | | | | | | | | | |
| 92 | 1-Bromo- | HFE-7100 | Methanol | 16.9% | 75.6% | 7.5% | 2 | 1 | 1 | 1 | 1 | 1 | 1 | 5 | 1 | Yes |
| | propane | | | | | | | | | | | | | | | |
| 93 | 1-Bromo- | HFE-7100 | Ethanol | 20.2% | 75.5% | 4.3% | | | | | | | | | | None |
| | propane | | | | | | | | | | | | | | | |
| 94 | 1-Bromo- | HFE-7100 | 2- | 21.1% | 75.0% | 3.9% | 4 | 1 | 1 | 1 | 1 | 1 | 1 | 3 | 1 | Yes |
| | propane | | Propanol | | | | | | | | | | | | | |
| 95 | 1-Bromo- | HFE-7100 | Methyl | 16.3% | 66.4% | 17.3% | 2 | 2 | 1 | 1 | 1 | 1 | 1 | 1 | 1 | Yes |
| | propane | | Acetate | | | | | | | | | | | | | |
| 96 | 1-Bromo- | HFE-7100 | Tetra- | 13.0% | 79.4% | 7.6% | 4 | 1 | 1 | 1 | 1 | 1 | 1 | 2 | 1 | None |
| | propane | | hydro- | | | | | | | | | | | | | |
| | | | furan | | | | | | | | | | | | | |
| 97 | 1-Bromo- | HFE-7100 | 1,3 | 19.3% | 76.4% | 4.3% | 4 | 1 | 1 | 1 | 1 | 1 | 1 | 2 | 2 | None |
| | propane | | Dioxolane | | | | | | | | | | | | | |
| 98 | 1-Bromo- | HFC-4310 | Methanol | 16.5% | 76.0% | 7.5% | 2 | 1 | 1 | 1 | 1 | 1 | 1 | 3 | 1 | None |
| | propane | | | | | | | | | | | | | | | |
| 99 | 1-Bromo- | HFC-4310 | 2- | 11.4% | 87.3% | 1.3% | 3 | 1 | 1 | 1 | 1 | 1 | 1 | 1 | 1 | None |
| | propane | | Propanol | | | | | | | | | | | | | |
| 100 | 1-Bromo- | HFE-7100 | Ethanol | 20.2% | 75.5% | 4.3% | 4 | 1 | 1 | 1 | 1 | 1 | 1 | 3 | 1 | |
| | propane | | | | | | | | | | | | | | | |
| 101 | 1-Bromo- | HFE-7100 | 1,2-trans- | 8.0% | 47.0% | 45.0% | 5 | 2 | 1 | 1 | 1 | 1 | 1 | 4 | 5 | |
| | propane | | dichloro- | | | | | | | | | | | | | |
| | | | ethylene | | | | | | | | | | | | | |

It should be apparent from the foregoing detailed description that the objects set forth at the outset to the specification have been successfully achieved. Moreover, while there is shown and described present preferred embodiments of the invention, it is to be distinctly understood that the invention is not limited thereto but may be otherwise variously embodied and practiced within the scope of the following claims.

What is claimed:

1. A composition for use a solvent and cleaner comprising a monobrominated hydrocarbon compound of the formula (I) CₓH₂ₓ₊₁Br where x is 2-12, or (II) C_{y}H_{2y-1}Br where y is 2-12, or mixtures thereof, and an additive selected from the group consisting of:
(A) a fluorinated compound of the formula CₐF_{b}H_{c}X_{d} where a is 1-16, b>c, c can be 1-16, d can be 0 or greater and X can be O, N, halogen, or Si, in any possible combination as long as the number of F atoms exceeds the number of H atoms in the molecule;
(B) an enhancement agent selected from the group consisting of alcohols, esters, ethers, cyclic ethers, ketones, alkanes, terpenes, dibasic esters, glycol ethers, pyrollidones, low or non-ozone depleting chlorinated and chlorinated/fluorinated hydrocarbons, and mixtures thereof; and
(C) mixtures thereof.

2. A composition as defined in claim 1, comprising effective amounts of said monobrominated hydrocarbon compound and said additive to form an azeotrope or azeotrope like composition.

3. A composition as defined in claim 1, wherein said monobrominated hydrocarbon compound of the formula (I) is selected from the group consisting of bromoethane, 1-bromopropane, 2-bromopropane, 1-bromobutane, 2-bromobutane, bromomethylpropane, 1-bromopentane, 2-bromopentane, 3-bromopentane, bromomethylbutane, bromocyclopentane, 1-bromohexane, 2-bromohexane, 3-bromohexane, bromomethylpentane, bromoethylbutane, bromocyclohexane, bromoheptane, bromooctane, bromononane, bromodecane, ethylhexyl bromide, and mixtures thereof.

4. A composition as defined in claim 1, comprising said monobrominated hydrocarbon compound of the formula (I) CₓH₂ₓ₊₁Br where x is 3 to 8.

5. A composition as defined in claim 4, where x is 3 to 6.

6. A composition as defined in claim 5, wherein said monobrominated hydrocarbon compound is 1-bromopropane or 2-bromopropane.

7. A composition as defined in claim 1, wherein said fluorinated compound is selected from the group consisting of trifluoromethane, perfluoromethane, tetrafluoroethane, pentafluoroethane, perfluoroethane, pentafluoropropane, hexafluoropropane, heptafluoropropane, perfluoropropane, hexafluorobutane, heptafluorobutane, octafluorobutane, nonafluorobutane, perfluorobutane, heptafluoropentane, octafluoropentane, nonafluoropentane, decafluoropentane, undecafluoropentane, perfluoropentane, octafluorohexane, nonafluorohexane, decafluorohexane, undecafluorohexane, dodecafluorohexane, tridecafluorohexane, perfluorohexane, 3-chloro-1,1,1 trifluoropropane, 1,1,1,3,3,5,5,5-octafluoropentane, 4-trifluoromethyl-1,1,1,2,2,3,3,5,5,5-decafluoropentane, 4-trifluoromethyl-1,1,1,2,2,5,5,5 octafluoropentane, 4-trifluoromethyl-1,1,1,2,2,3,5,5,5-nonafluoropentane, 1,1,1,2,3,4,4,5,5,5-decafluoropentane, 1,1,1,2,2,3,3,4,4,5,6-undecafluorohexane, 1,1,2,2,3,3,4,4-octafluorobutane, 1,1,1,2,2,3,3,4,4-nonafluorobutane-4-methyl ether, 1,1,1,2,2,3,4,4,4-nonafluoroisobutane-3-methyl ether, 1,1,1,2,2,3,3,4,4-nonafluorobutane-4-ethyl ether, 1,1,1,2,2,3,4,4,4-nonafluoroisobutane-3-ethyl ether, 1,1,2,2,3,3,4,5-octafluorocyclopentane, pentafluoroethane, dichloro-trifluoroethane, trichloro-tetrafluoropropane, dichloro-pentafluoropropane, dichloro-tetrafluoropropane, chloro-pentafluoropropane, chloro-tetrafluoropropane, chloro-hexafluoropropane, pentachloro-difluoropropane, tetrachloro-trifluoropropane, trichloro-trifluoropropane, pentafluoropropane, nonofluorobutylethylene and mixtures thereof.

8. A composition as defined in claim 1, comprising said fluorinated compound of the formula CₐF_{b}H_{c}X_{d} where a is 2 to 8.

9. A composition as defined in claim 4, where a is 3 to 7.

10. A composition as defined in claim 1, wherein said fluorinated compound is HFE-7100, HFC 43-10, HCFC-225, HCFC-123, PFBET, or octafluorocyclopentane.

11. A composition as defined in claim 1, wherein said alcohol is an alcohol of the formula CᵣHₛ(OH)ₜ where r is 1 to 18, s<2x+2 and t is 1 or 2.

12. A composition as defined in claim 11, wherein said alcohol is selected from the group consisting of methyl alcohol, ethyl alcohol, n-propyl alcohol, isopropyl alcohol, n-butyl alcohol, 2-butyl alcohol, t-butyl alcohol, 1-pentanol, 2-pentanol, 3-pentanol, trifluoroethanol, allyl alcohol, 1-hexanol, 2-hexanol, 3-hexanol, 2-ethyl hexanol, 1-octanol, 1-decanol, 1-dodecanol, cyclohexanol, cyclopentanol, benzyl alcohol, furfuryl alcohol, tetrahydrofurfuryl alcohol, bis-hydroxymethyl tetrahydrofuran, ethylene glycol, propylene glycol, butylene glycol, and mixtures thereof.

13. A composition as defined in claim 12, wherein said alcohol is selected from the group consisting of methanol, ethanol, isopropanol, t-butyl alcohol, and mixtures thereof.

14. A composition as defined in claim 11, where r is 1 to 8.

15. A composition as defined in claim 13, where r is 1 to 6 and t is 1.

16. A composition as defined in claim 1, wherein said ester is an ester of the formula R₁—COO—R₂ where R₁ is C₁-C₂₀alkyl, C₅-C₆ cycloalkyl, benzyl, furanyl or tetrahydrofuranyl, and R₂ is hydrogen, C₁-C₈ alkyl, C₅-C₆ cycloalkyl, benzyl, phenyl, furanyl or tetrahydrofuranyl.

17. A composition as defined in claim 16, wherein said ester is selected from the group consisting of methyl formate, methyl acetate, methyl propionate, methyl butyrate, ethyl formate, ethyl acetate, ethyl propionate, ethyl butyrate, propyl formate, propyl acetate, propyl propionate, propyl butyrate, butyl formate, butyl acetate, butyl propionate, butyl butyrate, methyl soyate, isopropyl myristate, propyl myristate, butyl myristate, and mixtures thereof.

18. A composition as defined in claim 17, wherein said ester is selected from the group consisting of methyl formate, methyl acetate, ethyl acetate, ethyl formate, and mixtures thereof.

19. The composition of claim 16, wherein R₁ and R₂ are the same or different and are C₁ to C₈.

20. A composition as defined in claim 19, wherein R₁, R₂ are C₁ to C₄.

21. A composition as defined in claim 1, wherein said ether is an ether of the formula R₃—O—R₄ where R₃ is C₁-C₁₀ alkyl or alkynl, C₅-C₆ cycloalkyl, benzyl, phenyl, furanyl or tetrahydrofuranyl, R₄ is C₁-C₁₀ alkyl or alkynl, C₅-C₆ cycloalkyl, benzyl, phenyl, furanyl or tetrahydrofuranyl.

22. A composition as defined in claim 21, wherein said ether is selected from the group consisting of ethyl ether, methyl ether, propyl ether, isopropyl ether, butyl ether, methyl t-butyl ether, ethyl t-buytl ether, vinyl ether, allyl ether, anisole, and mixtures thereof.

23. A composition as defined in claim 22, wherein said ether is selected from the group consisting of isopropyl ether, propyl ether, and mixtures thereof.

24. A composition as defined in claim 21, wherein R₃ and R₄ are C₁ to C₆ alkyl or alkynl.

25. A composition as defined in claim 24, wherein R₃ and R₄ are C₁ to C₄ alkyl.

26. A composition as defined in claim 1, wherein said cyclic ether is selected from the group consisting of 1,4 dioxane, 1,3 dioxolane, tetrahydrofuran (THF), methyl THF, dimethyl THF, tetrahydropyran (THP), methyl THP, dimethyl THP, ethylene oxide, propylene oxide, butylene oxide, amyl oxide, isoamyl oxide, and mixtures thereof.

27. A composition as defined in claim 26, wherein the cyclic ether is 1,3 dioxolane, THF, butylene oxide, or mixtures thereof.

28. A composition as defined in claim 1, wherein said ketone is a ketone of the formula R₅—C═O—R₆ where R₅ is C₁-C₁₀ alkyl, C₅-C₆ cycloalkyl, benzyl, furanyl or tetrahydrofuranyl, R₆ is C₁-C₁₀ alkyl, C₅-C₆ cycloalkyl, benzyl, phenyl, furanyl or tetrahydrofuranyl.

29. A composition as defined in claim 28, wherein said ketone is selected from the group consisting of acetone, methyl ethyl ketone, 2-pentanone, 3-pentanone, 2-hexanone, 3-hexanone, methyl isobutyl ketone, and mixtures thereof.

30. A composition as defined in claim 29, wherein said ketone is selected from the group consisting of acetone, methyl ethyl ketone, 3-pentanone, methyl isobutyl ketone, and mixtures thereof.

31. A composition as defined in claim 29, wherein R₅ and R₆ are C₁ to C₆ alkyl or alkynl.

32. A composition as defined in claim 31, wherein R₅ and R₆ are C₁ to C₄ alkyl.

33. A composition as defined in claim 1, wherein said alkane is an alkane of the formula CₙHₙ₊₂ where n is 1-20, or a C₄-C₂₀ cycloalkane.

34. A composition as defined in claim 33, wherein said alkane is selected from the group consisting of methane, ethane, propane, butane, methyl propane, pentane, isopentane, methyl butane, cyclopentane, hexane, cyclohexane, dimethylcyclohexane, ethylcyclohexane, isohexane, heptane, methyl pentane, dimethyl butane, octane, nonane, decane, and mixtures thereof.

35. A composition as defined in claim 34, wherein said alkane is selected from the group consisting of cyclopentane, cyclohexane, dimethylcyclohexane, ethylcyclohexane, hexane, methyl pentane, dimethyl butane, and mixtures thereof.

36. A composition as defined in claim 1, wherein said terpene contains at least 1 isoprene group of the general structure: 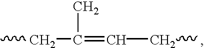
and may be cyclic or multicyclic.

37. A composition as defined in claim 36, wherein said terpene is selected from the group consisting of d-limonene, pinene, terpinol, terpentine, dipentene, and mixtures thereof.

38. A composition as defined in claim 37, wherein said terpene is d-limonene.

39. A composition as defined in claim 1, wherein said dibasic ester is a dibasic ester of the formula R₇—COO—R₈—COO—R₉ where R₇ is C₁-C₂₀ alkyl, C₅-C₆ cycloalkyl, benzyl, furanyl or tetrahydrofuranyl, R₈ is C₁-C₂₀ alkyl, C₅-C₆ cycloalkyl, benzyl, phenyl, furanyl or tetrahydrofuranyl, R₉ is C₁-C₂₀ alkyl, C₅-C₆ cycloalkyl, benzyl, furanyl or tetrahydrofuranyl.

40. A composition as defined in claim 39, wherein said dibasic ester is selected from the group consisting of dimethyl oxalate, dimethyl malonate, dimethyl succinate, dimethyl glutarate, dimethyl adipate, methyl ethyl succinate, methyl ethyl adipate, diethyl succinate, diethyl adipate, and mixtures thereof.

41. A composition as defined in claim 40, wherein said dibasic ester is selected from the group consisting of dimethyl succinate, dimethyl adipate, and mixtures thereof.

42. A composition as defined in claim 40, wherein R₇, R₈ and R₉ are the same or different, and are C₁ to C₆ alkyl or alkynl.

43. A composition as defined in claim 42, wherein R₇, R₈ and R₉ are the same or different, and are C₁ to C₄ alkyl.

44. A composition as defined in claim 1, wherein said glycol ether is a glycol ether of the formula: R₁₀—O—R₁₁—O—R₁₂ where R₁₀ is C₂-C₂₀ alkyl, C₅-C₆ cycloalkyl, benzyl, furanyl or tetrahydrofuranyl, R₁₁ is C₁-C₂₀ alkyl, C₅-C₆ cycloalkyl, benzyl, phenyl, furanyl or tetrahydrofuranyl, R₁₂ is hydrogen or an alcohol.

45. A composition as defined in claim 44, wherein when R₁₂ is an alcohol, said alcohol is selected from the group consisting of methyl alcohol, ethyl alcohol, propyl alcohol, isopropyl alcohol, n-butyl alcohol, 2-butyl alcohol, t-butyl alcohol, 1-pentanol, 2-pentanol, 3-pentanol, trifluoroethanol, allyl alcohol, 1-hexanol, 2-hexanol, 3-hexanol, 2-ethyl hexanol, 1-octanol, 1-decanol, 1-dodecanol, cyclohexanol, cyclopentanol, benzyl alcohol, furfuryl alcohol, tetrahydrofurfuryl alcohol, bis-hydroxymethyl tetrahydrofuran, ethylene glycol, propylene glycol, butylene glycol, and mixtures thereof.

46. A composition as defined in claim 44, wherein said glycol ether is selected from the group consisting of ethylene glycol methyl ether, diethylene glycol methyl ether, ethylene glycol ethyl ether, diethylene glycol ethyl ether, ethylene glycol propyl ether, diethylene glycol propyl ether, ethylene glycol butyl ether, diethylene glycol butyl ether, methyl methoxybutanol, propylene glycol methyl ether, dipropylene glycol, dipropylene glycol methyl ether, propylene glycol propyl ether, dipropylene glycol propyl ether, propylene glycol butyl ether, dipropylene glycol butyl ether, and mixtures thereof.

47. A composition as defined in claim 46, wherein said glycol ether is selected from the group consisting of propylene glycol butyl ether, dipropylene glycol methyl ether, dipropylene glycol, methyl methoxybutanol, diethylene glycol butyl ether, and mixtures thereof.

48. A composition as defined in claim 44, wherein R₁₀, R₁₁, and R₁₂ are C₁ to C₆ alkyl.

49. A composition as defined in claim 48, wherein R₁₀, R₁₁, and R₁₂ are C₁ to C₄ alkyl.

50. A composition as defined in claim 1, wherein said pyrrolidone is a pyrrolidone of the formula: 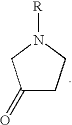
which is unsubstituted or substituted in the N position of the pyrrolidone ring by C₁ to C₆ alkyl, or C₁ to C₆ alkanol.

51. A composition as defined in claim 50, wherein said pyrrolidone is selected from the group consisting of pyrrolidone, N-methyl pyrrolidone, N-ethyl pyrrolidone, N-propyl pyrrolidone, N-hydroxymethyl pyrrolidone, N-hydroxyethyl pyrrolidone, N-hexyl pyrrolidone, and mixtures thereof.

52. A composition as defined in claim 51, wherein said pyrrolidone is selected from the group consisting of N-methyl pyrrolidone and N-ethyl pyrrolidone.

53. A composition as defined in claim 1, wherein said chlorinated hydrocarbon is of the formula R₁₃—Cl_{X} where R₁₃ is C₁-C₂₀ alkyl, C₁-C₂₀ alkenyl, C₄-C₁₀ cycloalkyl, C₂-C₂₀ alkenyl benzyl, phenyl, and X>1, and the Ozone Depletion Potential (ODP) of the molecule<0.15.

54. A composition as defined in claim 53, wherein said chlorinated hydrocarbon is selected from the group consisting of methyl chloride, methylene chloride, ethyl chloride, dichloro ethane, dichloro ethylene, propyl chloride, isopropyl chloride, propyl dichloride, butyl chloride, isobutyl chloride, sec-butyl chloride, t-butyl chloride, pentyl chloride, hexyl chloride, and mixtures thereof.

55. A composition as defined in claim 54, wherein said chlorinated hydrocarbon is selected from the group consisting of methylene chloride, dichloro ethylene, butyl chloride, and mixtures thereof.

56. A composition as defined in claim 1, further comprising a surfactant.

57. A composition as defined in claim 1, further comprising a perfume.

58. A composition as defined in claim 1, further comprising a corrosion inhibitor.

59. A composition as defined in claim 58, wherein said corrosion inhibitor is selected from the group consisting of alkanols having 4 to 7 carbon atoms, nitroalkanes having 1 to 3 carbon atoms, 1,2-epoxyalkanes having 2 to 7 carbon atoms, acetylene alcohols having 3 to 9 carbon atoms, phosphite esters having 12 to 30 carbon atoms, ethers having 3 to 6 carbon atoms, unsaturated hydrocarbon compounds having 4 to 7 carbon atoms, triazoles, acetals having 4 to 7 carbon atoms, ketones having 3 to 5 carbon atoms, amines having 6 to 8 carbon atoms, and mixtures thereof.

60. An azeotropic or azeotrope-like composition as defined in claim 1, comprising about 15-35 weight percent n-propyl bromide (NPB) and about 65-85 weight percent nonafluorobutane methyl ether (HFE-7100).

61. An azeotropic or azeotrope-like composition as defined in claim 60, comprising about 25 weight percent NPB and about 75 weight percent HFE-7100, having a boiling point at about 135° F. (about 56° C.).

62. An azeotropic or azeotrope-like composition as defined in claim 1, comprising about 13-33 weight percent NPB and about 67-87 weight percent 1,1,1,2,3,4,4,5,5,5 decafluoropentane (HFC-43-10mee).

63. An azeotropic or azeotrope-like composition as defined in claim 62, comprising about 23 weight percent NPB and about 77 weight percent HFC-43-10mee, having a boiling point of about 126° F. (about 52° C.).

64. An azeotropic or azeotrope-like composition as defined in claim 1, comprising about 70-90 weight percent NPB and about 10 to 30 weight percent 1,3 dioxolane.

65. An azeotropic or azeotrope-like composition as defined in claim 64, comprising about 79.5 weight percent NPB and about 20.5 weight percent 1,3 dioxolane, having a boiling point of about 134° F. (about 57° C.).

66. An azeotropic or azeotrope-like composition as defined in claim 1, comprising about 14-34 weight percent NPB and about 66-86 weight percent acetone.

67. An azeotropic or azeotrope-like composition as defined in claim 66, comprising about 24 weight percent NPB and about 76 weight percent acetone, having a boiling point of about 128° F. (about 53° C.).

68. An azeotropic or azeotrope-like composition as defined in claim 1, comprising about 75-95 weight percent NPB and about 5-25 weight percent isopropyl alcohol.

69. An azeotropic or azeotrope-like composition as defined in claim 68, comprising about 85 weight percent NPB and about 15 weight percent isopropyl alcohol, having a boiling point of about 154° F. (about 68° C.).

70. An azeotropic or azeotrope-like composition as defined in claim 1, comprising about 69-89 weight percent NPB and about 11-31 weight percent methanol.

71. An azeotropic or azeotrope-like composition as defined in claim 70, comprising about 79 weight percent NPB and about 21 weight percent methanol, having a boiling point of about 135° F. (about 57° C.).

72. An azeotropic or azeotrope-like composition as defined in claim 1, comprising about 85-99 weight percent NPB and about 1-15 weight percent n-propyl alcohol.

73. An azeotropic or azeotrope-like composition as defined in claim 72, comprising about 95 weight percent NPB and about 5 weight percent n-propyl alcohol, having a boiling point of about 158° F. (about 70° C.).

74. An azeotropic or azeotrope-like composition as defined in claim 1, comprising about 74-94 weight percent NPB and about 6-26 weight percent t-butyl alcohol.

75. An azeotropic or azeotrope-like composition as defined in claim 74, comprising about 84 weight percent NPB and about 16 weight percent t-butyl alcohol, having a boiling point of about 154° F. (about 68° C.).

76. An azeotropic or azeotrope-like composition as defined in claim 1, comprising about 15-35 weight percent NPB and about 65-85 weight percent nonafluorobutylethylene.

77. An azeotropic or azeotrope-like composition as defined in claim 76, comprising about 25 weight percent NPB and about 75 weight percent nonafluorobutylene, having a boiling point of about 131° F. (about 55° C.).

78. An azeotropic or azeotrope-like composition as defined in claim 1, comprising about 93-73 weight percent NPB and about 7-27 weight percent ethanol.

79. An azeotropic or azeotrope-like composition as defined in claim 78, comprising about 83 weight percent NPB and about 17 weight percent ethanol, having a boiling point of about 147° F. (about 64° C.).

80. An azeotropic or azeotrope-like composition as defined in claim 1, comprising about 01.-10 weight percent 2-bromopropane and about 99.9-90 weight percent trifluorodichloroethane (HCFC-123).

81. An azeotropic or azeotrope-like composition as defined in claim 80, comprising about 2 weight percent 2-bromopropane and about 98 weight percent trifluorodichloroethane (HCFC-123), having a boiling point of about 88° F. (about 31° C.).

82. An azeotropic or azeotrope-like composition as defined in claim 1, comprising about 81-99 weight percent NPB and about 1-19 weight percent allyl alcohol.

83. An azeotropic or azeotrope-like composition as defined in claim 82, comprising about 91 weight percent NPB and about 9 weight percent allyl alcohol, having a boiling point of about 157° F. (about 69° C.).

84. An azeotropic or azeotrope-like composition as defined in claim 1, comprising about 70-90 weight percent NPB and about 10-30 weight percent ethyl acetate.

85. An azeotropic or azeotrope-like composition as defined in claim 84, comprising about 80 weight percent NPB and about 20 weight percent ethyl acetate, having a boiling point of about 159° F. (about 71° C.).

86. An azeotropic or azeotrope-like composition as defined in claim 1, comprising about 35-55 weight percent NPB and about 45-65 weight percent propyl.

87. An azeotropic or azeotrope-like composition as defined in claim 86, comprising about 45 weight percent NPB and about 55 weight percent propyl formate, having a boiling point of about 151° F. (about 66° C.).

88. An azeotropic or azeotrope-like composition as defined in claim 1, comprising about 84-99.9 weight percent NPB and about 0.1-16 weight percent nitromethane.

89. An azeotropic or azeotrope-like composition as defined in claim 88, comprising about 94 weight percent NPB and about 6 weight percent nitromethane formate, having a boiling point of about 158° F. (about 70° C.).

90. An azeotropic or azeotrope-like composition as defined in claim 1, comprising about 18-38 weight percent isopropyl bromide (IPB), about 48-68 weight percent nonafluorobutane methyl ether (HFE-7100) and about 3-23 weight percent acetone.

91. An azeotropic or azeotrope-like composition as defined in claim 90, comprising about 28.5 weight percent isopropyl bromide (IPB), about 58.0 weight percent nonafluorobutane methyl ether (HFE-7100) and about 13.5 weight percent acetone, having a boiling point of about 124° F. (about 51° C.).

92. An azeotropic or azeotrope-like composition as defined in claim 1, comprising about 10-30 weight percent n-propyl bromide (NPB), about 60-80 weight percent nonafluorobutane methyl ether (HFE-7100) and about 10-30 weight percent acetone.

93. An azeotropic or azeotrope-like composition as defined in claim 92, comprising about 9.5 weight percent n-propyl bromide (NPB), about 70.0 weight percent nonafluorobutane methyl ether (HFE-7100) and about 20.5 weight percent acetone, having a boiling point of about 127° F. (about 53° C.).

94. An azeotropic or azeotrope-like composition as defined in claim 1, comprising about 17-37 weight percent n-propyl bromide (NPB), about 66-86 weight percent nonafluorobutane methyl ether (HFE-7100) and about 0.1-14 weight percent methanol.

95. An azeotropic or azeotrope-like composition as defined in claim 94, comprising about 16.9 weight percent n-propyl bromide (NPB), about 75.6 weight percent nonafluorobutane methyl ether (HFE-7100) and about 7.5 weight percent methanol, having a boiling point of about 116° F. (about 47° C.).

96. An azeotropic or azeotrope-like composition as defined in claim 1, comprising about 7-27 weight percent n-propyl bromide (NPB), about 56-76 weight percent nonafluorobutane methyl ether (HFE-7100) and about 7-27 weight percent methyl acetate.

97. An azeotropic or azeotrope-like composition as defined in claim 96, comprising about 16.3 weight percent n-propyl bromide (NPB), about 66.4 weight percent nonafluorobutane methyl ether (HFE-7100) and about 17.3 weight percent methyl acetate, having a boiling point of about 130° F. (about 54° C.).

98. An azeotropic or azeotrope-like composition as defined in claim 1, comprising about 3-23 weight percent n-propyl bromide (NPB), about 69-89 weight percent nonafluorobutane methyl ether (HFE-7100) and about 1-17 weight percent tetrahydrofuran.

99. An azeotropic or azeotrope-like composition as defined in claim 98, comprising about 13.0 weight percent n-propyl bromide (NPB), about 79.4 weight percent nonafluorobutane methyl ether (HFE-7100) and about 7.6 weight percent tetrahydrofuran, having a boiling point of about 137° F.

100. An azeotropic or azeotrope-like composition as defined in claim 1, comprising about 11-31 weight percent n-propyl bromide (NPB), about 65-85 weight percent nonafluorobutane methyl ether (HFE-7100) and about 1-14 weight percent isopropyl alcohol.

101. An azeotropic or azeotrope-like composition as defined in claim 100, comprising about 21.1 weight percent n-propyl bromide (NPB), about 75.0 weight percent nonafluorobutane methyl ether (HFE-7100) and about 3.9 weight percent isopropyl alcohol, having a boiling point of about 131° F. (about 55° C.).

102. An azeotropic or azeotrope-like composition as defined in claim 1, comprising about 30-50 weight percent n-propyl bromide (NPB), about 34-54 weight percent nonafluorobutane methyl ether (HFE-7100) and about 5-25 weight percent cyclopentane.

103. An azeotropic or azeotrope-like composition as defined in claim 102, comprising about 39.9 weight percent n-propyl bromide (NPB), about 44.6 weight percent nonafluorobutane methyl ether (HFE-7100) and about 15.6 weight percent cyclopentane, having a boiling point of about 111° F. (about 44° C.).

104. An azeotropic or azeotrope-like composition as defined in claim 1, comprising about 7-27 weight percent n-propyl bromide (NPB), about 66-86 weight percent 1,1,1,2,3,4,4,5,5,5 decafluoropentane (HFC-43-10mee), and about 7-27 weight percent methanol.

105. An azeotropic or azeotrope-like composition as defined in claim 104, comprising about 16.5 weight percent n-propyl bromide (NPB), about 76.0 weight percent 1,1,1,2,3,4,4,5,5,5 decafluoropentane (HFC-43-10mee), and about 7.5 weight percent methanol, having a boiling point of about 116° F. (about 47° C.).

106. An azeotropic or azeotrope-like composition as defined in claim 1, comprising about 2-22 weight percent n-propyl bromide (NPB), 77-97 weight percent 1,1,1,2,3,4,4,5,5,5 decafluoropentane (HFC-43-10mee), and 1-12 weight percent isopropanol.

107. An azeotropic or azeotrope-like composition as defined in claim 106, comprising about 11.4 weight percent n-propyl bromide (NPB), about 87.3 weight percent 1,1,1,2,3,4,4,5,5,5 decafluoropentane (HFC-43-10mee), and about 1.3 weight percent isopropanol, having a boiling point of about 127° F. (about 53° C.).

108. An azeotropic or azeotrope-like composition as defined in claim 1, comprising about 9-29 weight percent n-propyl bromide (NPB), 66-86 weight percent nonafluorobutane methyl ether (HFE-7100) and 0.1-14 weight percent 1,3-dioxolane.

109. An azeotropic or azeotrope-like composition as defined in claim 108, comprising about 19.3 weight percent n-propyl bromide (NPB), about 76.4 weight percent nonafluorobutane methyl ether (HFE-7100) and about 4.3 weight percent 1,3-dioxolane, having a boiling point of about 133° F. (about 56° C.).

110. An azeotropic or azeotrope-like composition as defined in claim 1, comprising about 10-30 weight percent n-propyl bromide (NPB), about 66-86 weight percent nonafluorobutane methyl ether (HFE-7100) and about 0.1-14 weight percent ethanol.

111. An azeotropic or azeotrope-like composition as defined in claim 110, comprising about 20.2 weight percent n-propyl bromide (NPB), 75.5 weight percent nonafluorobutane methyl ether (HFE-7100) and 4.3 weight percent ethanol, having a boiling point of about 122° F. (about 50° C.).

112. An azeotropic or azeotrope-like composition as defined in claim 1, comprising about 0.1-18 weight percent NPB, 37-57 weight percent nonafluorobutane methyl ether (HFE-7100), and 35-55 weight percent 1,2-trans-dichloroethylene.

113. An azeotropic or azeotrope-like composition as defined in claim 112, comprising about 8 weight percent NPB, 47 weight percent HFE-7100, and 45 weight percent 1,2-trans-dichloroethylene, having a boiling point of about 116° F. (about 47° C.).

114. An azeotropic or azeotrope-like composition as defined in claim 1, comprising about 25-45 weight percent NPB, 45-65 weight percent 1,1,1,2,3,4,4,5,5,5-decafluoropentane (HFC 43-10mee), and 0.1-20 weight percent acetone.

115. An azeotropic or azeotrope-like composition as defined in claim 114, comprising about 35 weight percent NPB, 55 weight percent HFC 43-10mee, and 10 weight percent acetone, having a boiling point of about 128° F. (about 53° C.).

116. An azeotropic or azeotrope-like composition as defined in claim 1, comprising about 5-25 weight percent NPB, 69-89 weight percent nonafluorobutylethylene (PFBET), and 0.1-18 weight percent methanol.

117. An azeotropic or azeotrope-like composition as defined in claim 116, comprising about 15 weight percent NPB, 79 weight percent PFBET, and 8 weight percent methanol, having a boiling point of about 113° F. (about 45° C.).

118. A method of cleaning a solid surface which comprises treating said surface with a composition as defined in claim 1.

119. The method of claim 118, wherein the solid surface is a printed circuit board, silicon wafer, electrical component or microelectronic device contaminated with flux, rosin, adhesive, oil, grease, photoresist and/or polymers.

120. The method of claim 118, wherein the solid surface is an optical device, lens or optical mold contaminated with flux, rosin, ink, wax, dirt, resin, adhesive, buffing compound, oil, grease and/or polymers.

121. The method of claim 118, wherein the solid surface is metal, plastic, cloth or glass contaminated with dirt, flux, rosin, resin, ink, wax, adhesive, paint, latex, oil and/or polymers.

122. The method of claim 118, where the composition is contacted with the surface at a temperature from 32° F. (0° C.) to and including the boiling point of the composition.

123. The method of claim 118, where the mixture is contacted with the surface as an aerosol.

124. The method of claim 118, where the mixture is contacted with the surface as a liquid.

125. The method of claim 118, where the mixture is contacted with the surface as a vapor.

126. A method of solvating a solid or liquid material by contacting said material with a composition as defined in claim 1.

127. The method of claim 126, where the composition is contacted with the material in a temperature range from 32° F. (0° C.) to and including the boiling point of the composition to thereby dissolve the material.
